(19) United States
(12) Patent Application Publication
(10) Pub. No.: US 2006/0233462 A1
(43) Pub. Date: Oct. 19, 2006

(54) Method for optically identifying coordinate information and system using the method

(76) Inventors: Cheng-Hua Huang, Hsinchu (TW); Yu-Kei Chen, Chia-I (TW); Ching-Ho Chen, Taoyuan Hsien (TW); Yang-Ming Shih, Hsinchu (TW)

Correspondence Address: HERSHKOVITZ & ASSOCIATES, 2845 DUKE STREET, ALEXANDRIA, VA, 22314, US

(21) Appl. No.: 11/104,590

(22) Filed: Apr. 13, 2005

(51) Int. Cl. G06K 9/36

(52) U.S. Cl. 382/291

(57) ABSTRACT

A method and system are provided to identify coordinate information of a selected position on a three-dimensional object or on a leaf among plural pages with pre-formed reference indications. While identifying the coordinated information on the leaf, identification of page number is accomplished based on the reference indications formed around margins of the sheet. Moreover, by using at least one corner of the leaf and symbols printed around the margins as the reference coordinate data, the actual coordinate information of the selected position is derived. Corresponding to the actual coordinated information, accessory data in a form of voice, image or text are then output.

### BACKGROUND OF THE INVENTION

1. Field of the Invention

The present invention relates to a method for optically identifying coordinate information and a system adopting the method, more particularly, the method and the system are able to identify coordinate data on a surface of an object based on preformed marks, and further output accessory data related to the derived coordinate data.

2. Description of Related Art

The application of optical identification technology has become widely known and seen in daily life. For example, the use of bar codes on goods to rapidly yet simply determine the price of goods at a check-out may be the most common application. Moreover, as disclosed in a Taiwan Patent 581970 entitled “An electronic device using the index pattern”, the reference is also related to the present application of optical identification. In the patent, a main pattern as well as an index pattern coexist on a surface of an object. The index pattern is difficult to be noticed by people and will not cause any interference while the main pattern is being recognized, but is recognizable by the optical apparatus. Generally, the index pattern stands for the connoted information of the object.

The index pattern may consist of multiple basic pattern units arranged in an array form. For example, while people suddenly seethe mesh points in FIG. 1(A) of the cited patent, they seem to be a meaningless decorative picture. For example, upon first glimpse of the mesh points in FIG. 1(A), they seem to be merely decorations, however, if the mesh points are examined closely, it is found that they are actually formed by multiple basic pattern units with a unique arrangement. The basic pattern units are deemed as secret codes containing additional information of the object, such as its price. When the optical apparatus successfully recognizes the basic pattern units, the hidden information can be accordingly revealed.

Although the proposed secret codes can be applied in many fields such as the identification of product kinds and anti-counterfeiting, precise and complex printing procedures are required while forming the secret codes. Otherwise, the tiny secret codes will be too blurred to be recognizable for the optical apparatus.

### SUMMARY OF THE INVENTION

The main objective of the present invention is to provide a method for optically identifying coordinate information and a system using the method, wherein by using simple reference indications, coordinate data of a selected position either on a 3-D object or a 2-D object is easily to be calculated. Further, based on the derived coordinate information, accessory data in a form of voice, image etc., are then correspondingly output.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an optical identification device in accordance with the present invention;

FIG. 2 is a plan view of a page of a book to be identified;

FIG. 3 is an operational view showing the optical identification device is used to identify a coordinate on a book; and

FIG. 4 is another operational view showing the optical identification device is used to identify a coordinate on a three-dimensional object.

### DETAILED DESCRIPTION OF THE PREFERRED EMBODIMENT

The present invention provides a method and an optical device to implement coordinate information identification on a surface of either a two-dimensional or a three-dimensional (respectively 2-D and 3-D hereinafter) object.

The coordinate identification for the 2-D object is firstly described hereinafter. Using a book as the example, the invention is able to recognize the page number of a chosen leaf among multiple pages and then locates coordinate information of a selected position on the sheet. After the coordinate information is recognized by the optical device, accessory data corresponding to the coordinate information is output, wherein the output accessory data may be in the form of voice, image, text etc.

In an example that the present invention is applied to a children's book as the interactive teaching materials, the optical device firstly identifies which page is being read. The reader can hold and move the optical device to a position on the paper where a pictures of animals or plants etc are illustrated. After the optical device locates the coordinate information of that position, a data output unit embedded in the optical device may generate corresponding sound based on the derived coordinate to tell a story or introduce the related information of the picture.

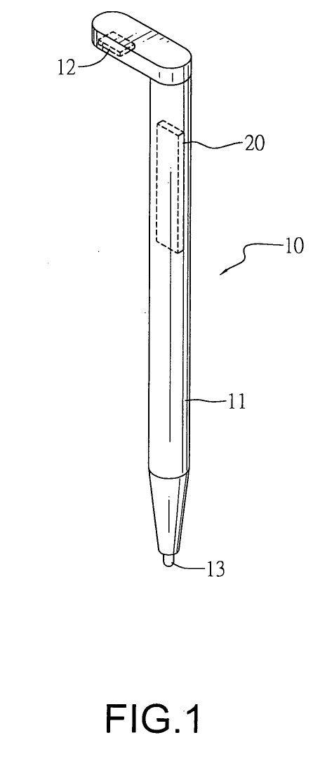

With reference to FIG. 1, the optical device (10) in accordance with the present invention has an appearance like a pen. The optical device (10) comprises a hollow body (11) with a top end and a bottom end. An image capture element (12) is mounted at the top end, and an index point (13) is formed at the bottom end. An image processing circuit, a coordinate calculation circuit as well as the data output unit (20) are retained inside the hollow body (11), wherein the data output unit (20) is a voice output circuit in the embodiment.

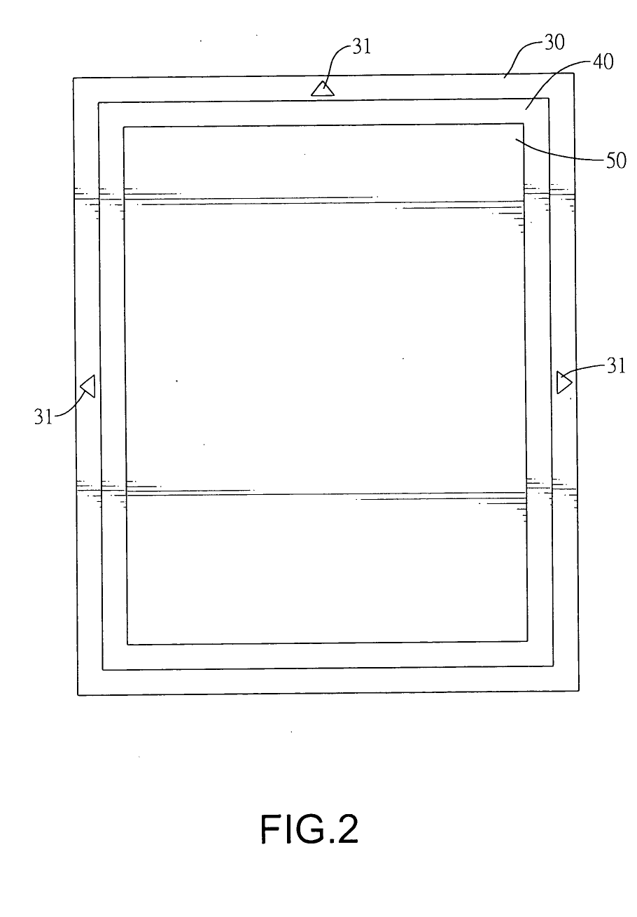

With reference to FIG. 2, the optical device (10) is applied to identify coordinate information on a plane, for example a book. The identifying process mainly comprises two stages. In the first stage, the optical device (10) identifies the page number of a sheet being reviewed from all pages. In the second stage, when the index point (13) moves to a position on the sheet, the coordinate calculation circuit inside the optical device (10) can calculate the coordinate of that position. The details of the two stages are described as following.

I. First Stage: Identification of Page Number

Still referring to FIG. 2, the margin of the sheet to be identified is printed with a first index color (30) as the reference indications. The first index color (30) is consisted of apparently distinguishable colors such as red, green, blue, white, black or brown. The distribution ratios of the three basic colors R, G and B in the foregoing given colors are apparently different from others. For example, the red, green and white can be respectively expressed by (255, 0, 0), (0,255,0) and (255, 255, 255), while the black is represented by (0, 0, 0). Based on the apparent different distributions of the basic colors, the optical device (10) can have higher accuracy in recognition of the first index color (30).

A space (40) is formed adjacent to and inside the first index color (30). Preferably, the color forming the space (40) is different from the first index color (30), for example the white. A second index color (50) is then printed inside the space (40). The second index color (50) can be any kind of colors. Therefore, the original color printed on the papers can be directly adopted as the second index color (50).

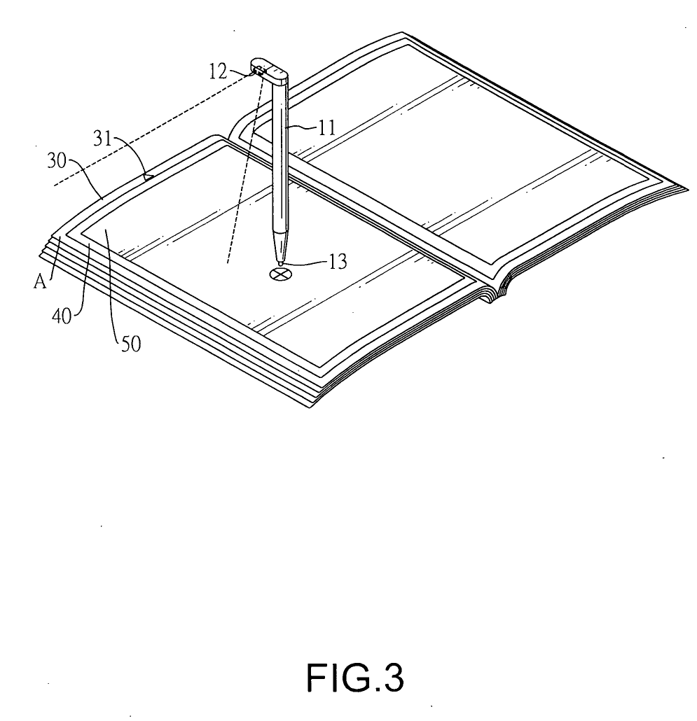

With reference to FIG. 3, when the image capture element (12) scans the sheet, the optical device (10) is able to recognize the first index color (30) and the second index color (50) because of the existence of the space (40). Based on the combination of the two index colors (30) and (50), the optical device (10) compares the detected combination with a database to find out the exact page number of the sheet. The database is created in the optical device (10) and stores many different combinations of the two index colors (30) and (50), each of which stands for a unique page number.

The identification of page number in accordance with the present invention is based on the comparison result of a combination of different colors and a pre-created database, as described above. However, with the increase in the amount of pages, the first index color (30) can be chosen from more apparent colors. In another alternative, plural bars each of a different color can be printed around the margins of the paper sheet, not limited to only one index color (30) In the foregoing description, only one bar is printed around the periphery, i.e. the first index color (30). However, plural bars, each having a color different from others, can be printed around the periphery. Furthermore, the first index color (30) can be printed only along at least one edge of the sheet, not around the entire periphery.

Besides the use of the different color combinations, the reference indications can be implemented by symbols printed on the edges to obtain the desired information. According to the shapes, position or arrangements of the printed symbols, the page number information also can be identified.

II. Second Stage: Identification of Coordinate

With reference to FIG. 3, plural marks (31) are further printed near the edge of the sheet, wherein each mark (31) has a color different from the first index color (30) is formed on a middle position of the edge. A position on the sheet designated with “⊕” means a location to be identified. It is noted that the symbol “⊕” is only for demonstration purpose only. In practical application, the position to be identified may be printed with any kind of picture, not the symbol.

When the index point (13) of the optical device (10) indicates to the position “⊕” of the sheet, at least one corner (A) of the sheet and the mark (31) are covered within the effective region of the image capture element (12). A substantial triangular relationship is formed by the corner (A), the mark (31) and the position “⊕”. Because the distance between the mark (31) and the corner (A) is given, and the length of the optical device (10) and the relative position relationship between the point (13) and image capture element (12) image are known, the coordinate calculation circuit inside the optical device (10) can accordingly figure out the actual coordinate information of the position “⊕”. Once the coordinate information is obtained, the optical device (10) then outputs a voice data corresponding to the position.

In the case that the present invention is used as a teaching material, the user is allowed to record the desired voice files in the optical device, wherein the record voice files correspond to the interested positions of the teaching materials.

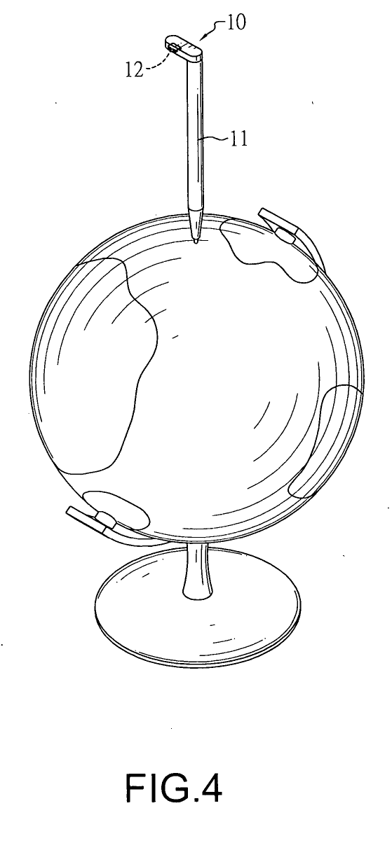

With reference to FIG. 4, the present invention is also suitable to identify coordinate information on a 3-D object without needing the foregoing first stage of page number identification. For example, the optical device (10) can use the foregoing coordinate identification process to obtain the coordinate information of a selected position on the globe. Then, based on the derived coordinate information, the optical device (10) outputs related data such as the name of the country being indicated.

In short, the page number can be recognized by detecting the combination of colors printed near the margins of a 2-D object, or by detecting the positions of marks distributed along the edges of a page. After these reference data have been derived, the desired coordinate information of a select position can be calculated according to the known trigonometrical algorithm. Such an optical coordinate identification process is able to be applied in the interactive teaching materials, game devices and so on. The application of the present invention can be further extended to the 3-D object, where the coordinate information of a selected point on the surface of the 3-D object is recognizable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for optically identifying coordinate information comprising the acts of:
forming reference indications near at least one margin of a sheet to be identified;
detecting the reference indications to identify page number information of the sheet;
using an optical device to point to a selected position on the sheet, and to capture at least one corner of the sheet and at least one mark printed on the margin of the sheet so as to generate reference coordinate information; and
calculating actual coordinate information of the selected position based on the reference coordinate information and position data of the optical device itself.

2. The method as claimed in claim 1, wherein the reference indications near the at least one margin of the sheet are formed by different colors.

3. The method as claimed in claim 1, wherein the reference indications near the at least one margin of the sheet are formed by symbols.

4. The method as claimed in claim 2, wherein the reference indications comprise a first index color, a second index color and a space formed between the first index color and the second index color.

5. The method as claimed in claim 4, wherein the first index color is chosen from red, green, blue, white, black or brown, and the space is white.

6. The method as claimed in claim 5, wherein the first index color, the space and the second index color are sequentially formed from the outermost periphery of the sheet to an inner region of the sheet.

7. The method as claimed in claim 5, wherein the second index color is an original color printed on the sheet.

8. The method as claimed in claim 1, the optical device formed with an appearance resembling a pen with two ends, where an image capture element is mounted at one end and the other end is used as an index point; the image capture element captures the corner of the sheet and the mark printed on the sheet to generate the reference coordinate information; wherein the position data of the optical device comprises a length of the optical device and a position relationship between the image capture element and the index point.

9. The method as claimed in claim 8, the method further comprising an act of outputting accessory data corresponding to the calculated coordinated information of the selected position.

10. The method as claimed in claim 9, wherein the accessory data is in the form of voice, image, or text.

11. The method as claimed in claim 10, wherein the accessory data is output from the optical device.

12. An optical coordinate information identifying system comprising:
an object with plural sheets to be identified, wherein reference indications are formed near at least one margin of each sheet for page number identifying;
an optical device formed by a hollow body with two ends, where an image capture element is mounted at one end while the other end is used as an index point; an image processing circuit and a coordinate calculation circuit are retained inside the hollow body; when the index point moves to a selected position, the coordinate calculation circuit calculates coordinate information of the selected position; and
a data output unit mounted inside the hollow body to output an accessory data corresponding to the selected position.

13. The system as claimed in claim 12, wherein the reference indications near the at least one margin of the sheet are formed by different colors.

14. The system as claimed in claim 12, wherein the reference indications near the at least one margin of the sheet are formed by symbols.

15. The system as claimed in claim 12, wherein the data output circuit is a voice output circuit.

16. The system as claimed in claim 12, the accessory data is in the form of voice, image, or text.

17. The system as claimed in claim 13, wherein the reference indications comprises a first index color, a second index color and a space formed between the first index color and the second index color.

18. The system as claimed in claim 17, wherein the first index color is chosen from red, green, blue, white, black or brown, and the space is white.

19. The system as claimed in claim 17, wherein the first index color, the space and the second index color are sequentially formed from the outermost periphery to an inner region on the sheet.

20. The system as claimed in claim 17, wherein the second index color is an original color printed on the sheet.

21. The system as claimed in claim 17, wherein the optical device has an appearance of a pen.

22. A method for optically identifying coordinate information on a 3-D object, comprising the acts of:
forming reference indications on a surface of the object to be identified;
using an optical device to point to a selected position on the object, and to detecting the reference indications so as to generate reference coordinate information; and
calculating actual coordinate information of the selected position based on the reference coordinate information and position data of the optical device itself.

23. The method as claimed in claim 22, wherein the reference indications are formed by different colors.

24. The method as claimed in claim 22, wherein the reference indications are formed by symbols.

25. The method as claimed in claim 22, wherein the optical device has an appearance of a pen with two ends, where an image capture element is mounted at one end and the other end is used as an index point; the image capture element captures the corner of the sheet and the mark printed on the sheet to generate the reference coordinate information; wherein the position data of the optical device comprises a length of the optical device and a relative position relationship between the image capture element and the index point.

26. The method as claimed in claim 23, wherein the optical device has an appearance of a pen with two ends, where an image capture element is mounted at one end and the other end is used as an index point; the image capture element captures the corner of the sheet and the mark printed on the sheet to generate the reference coordinate information; wherein the position data of the optical device comprises a length of the optical device and a relative position relationship between the image capture element and the index point.

27. The method as claimed in claim 24, the optical device has an appearance of a pen with two ends, where an image capture element is mounted at one end and the other end is used as an index point; the image capture element captures the corner of the sheet and the mark printed on the sheet to generate the reference coordinate information; wherein the position data of the optical device comprises a length of the optical device and a position relationship between the image capture element and the index point.

28. The method as claimed in claim 24, the method further comprising an act of outputting accessory data corresponding to the calculated coordinated information of the selected position.

29. The method as claimed in claim 28, wherein the accessory data is in the form of voice, image, or text.

30. The method as claimed in claim 29, wherein the accessory data is output from the optical device.
